(19) United States
(12) Patent Application Publication
(10) Pub. No.: US 2026/0015473 A1
(43) Pub. Date: Jan. 15, 2026

(54) COMPOSITION

(71) Applicant: AGC INC., Tokyo (JP)

(72) Inventor: Osamu FUJIOKA, Yokohama-shi (JP)

(73) Assignee: AGC INC., Tokyo (JP)

(21) Appl. No.: 19/329,832

(22) Filed: Sep. 16, 2025

Related U.S. Application Data
(63) Continuation of application No. PCT/JP2024/013556, filed on Apr. 2, 2024.

(30) Foreign Application Priority Data
Apr. 6, 2023 (JP) 2023-062181

(51) Int. Cl. C08J 5/18; C08K 3/36

(52) U.S. Cl. CPC C08J 5/18; C08K 3/36; C08J 2327/18; C08K 2201/005; C08K 2201/006

(57) ABSTRACT

To provide a composition excellent in dispersibility, from which a molded product having a low coefficient of linear expansion, dielectric constant and dielectric loss tangent can be formed.

A composition comprising particles of a tetrafluoroethylene-based polymer and hollow silica particles with a 20% burst pressure of 120 MPa or more, with a ratio of the specific surface area of the hollow silica particles to the specific surface area of the particles of the tetrafluoroethylene-based polymer being more than 1 and with the content of the hollow silica particles being 30 vol % or more.

### TECHNICAL FIELD

The present invention relates to a predetermined composition comprising particles of a tetrafluoroethylene-based polymer and specific hollow silica particles.

### BACKGROUND ART

In recent years, to meet the demand for higher speeds and higher frequency of mobile communicant devices such as mobile phones, for materials of printed circuit boards of communication devices, a material having high thermal conductivity, a low coefficient of linear expansion, a low dielectric constant and a low dielectric loss tangent is required, and a tetrafluoroethylene-based polymer having a low dielectric constant and a low dielectric loss tangent has attracted attention.

In order to develop a material which may satisfy properties of a low dielectric constant and a low dielectric loss tangent, which is required particularly in the field of printed circuit board materials, a composition of a tetrafluoroethylene-based polymer with other components has been studied. Patent Document 1 proposes a composition containing particles of a tetrafluoroethylene-based polymer, hollow particles and inorganic particles in a specific volume concentration ratio. Patent Document 2 proposes a composition containing a liquid crystalline polyester resin, polytetrafluoroethylene and an inorganic hollow filler, which has specific electric properties. Patent Document 3 proposes an aqueous coating composition containing particles of a tetrafluoroethylene-based polymer, silica particles with a specific particle size, a non-fluorinated surfactant and a glycol-based solvent in a specific mass ratio.

### PRIOR ART DOCUMENTS

### Patent Documents

Patent Document 1: WO2023/276946

Patent Document 2: WO2021/187399

Patent Document 3: WO2022/097678

### DISCLOSURE OF INVENTION

### Technical Problem

A tetrafluoroethylene-based polymer has a low surface tension and is hardly miscible with other components. Accordingly, a composition containing the tetrafluoroethylene-based polymer and another component may provide a molded product which dose not sufficiently exhibit physical properties of the respective components. Hollow particles have a function to allow a molded product containing the hollow particles to have a reduced dielectric constant and dielectric loss tangent, due to air contained therein, however, they are likely to break, and the molded product can hardly exhibit the properties of the hollow particles sufficiently.

The present inventors have found that a composition comprising particles of a tetrafluoroethylene-based polymer and specific hollow silica particles in a predetermined ratio, with the ratio of the specific surface areas of the particles set within a predetermined range, is excellent in dispersibility and a molded product thereof has a low coefficient of linear expansion, dielectric constant and dielectric loss tangent, and accomplished the present invention. The object of the present invention is to provide such a composition.

### Solution to Problem

The present invention provides the following.
[1] A composition comprising particles of a tetrafluoroethylene-based polymer and hollow silica particles with a 20% burst pressure of 120 MPa or more, with a ratio of the specific surface area of the hollow silica particles to the specific surface area of the particles of the tetrafluoroethylene-based polymer being more than 1 and with a content of the hollow silica particles being 30 vol % or more.
[2] The composition according to [1], wherein the tetrafluoroethylene-based polymer contains units based on a perfluoro(alkyl vinyl ether).
[3] The composition according to [1] or [2], wherein the tetrafluoroethylene-based polymer is a heat-meltable tetrafluoroethylene-based polymer having a carbonyl group-containing group.
[4] The composition according to any one of [1] to [3], wherein the particles of the tetrafluoroethylene-based polymer have an average particle size of 0.1 μm or more and less than 10 μm.
[5] The composition according to any one of [1] to [4], wherein the particles of the tetrafluoroethylene-based polymer have a specific surface area of 5 m²/g or more and 18 m²/g or less.
[6] The composition according to any one of [1] to [5], wherein the hollow silica particles have an average particle size of 0.1 μm or more and less than 10 μm.
[7] The composition according to any one of [1] to [6], wherein the hollow silica particles have a specific surface area of more than 6.5 m²/g and 100 m²/g or less.
[8] The composition according to any one of [1] to [7], wherein the content of the hollow silica particles is 35 vol % or more and 60 vol % or less.
[9] The composition according to any one of [1] to [8], wherein the hollow silica particles have a dielectric constant of less than 3.0 at a frequency of 1 GHz.
[10] The composition according to any one of [1] to [9], wherein the hollow silica particles have a dielectric loss tangent of 0.002 or less at a frequency of 1 GHz.
[11] The composition according to any one of [1] to [10], wherein the ratio of the specific surface area of the hollow silica particles to the specific surface area of the particles of the tetrafluoroethylene-based polymer is 2 or more and 10 or less.
[12] The composition according to any one of [1] to [11], used to obtain a molded product with a dielectric constant of 2.8 or less and a dielectric loss tangent of 0.0025 or less.
[13] A method for producing a sheet, which comprises extruding the composition as define in any one of [1] to [12] to obtain a sheet comprising the tetrafluoroethylene-based polymer and the hollow silica particles.
[14] A method for producing a laminate, which comprises disposing the composition as defined in any one of [1] to [12] on the surface of a substrate, and forming a polymer layer containing the tetrafluoroethylene-based polymer, and the hollow silica particles, thereby to obtain a laminate having a substrate layer composed of the substate and the polymer layer.

### Advantageous Effects of Invention

According to the present invention, provided is a composition comprising particles of a tetrafluoroethylene-based polymer and specific hollow silica particles, which is excellent in dispersibility. From the composition, a molded product having a low coefficient of linear expansion, dielectric constant and dielectric loss tangent can be formed.

### DESCRIPTION OF EMBODIMENTS

The following terms have the following meanings.

The “average particle size (D50)” is a volume-based cumulative 50% size of particles determined by laser diffraction/scattering method. That is, the particle size distribution is measured by laser diffraction/scattering method, a cumulative curve is obtained taking the total volume of the group of particles being 100%, and the particle size at a point when the cumulative volume becomes 50% on the cumulative curve is taken as the average particle size.

D50 of the particles is determined by dispersing the particles in water and analyzing the particle sizes by laser diffraction/scattering method using a laser diffraction/scattering particle size distribution analyzer (manufactured by HORIBA, Ltd., model: LA-920).

“D90” is a cumulative volume particle size of particles, and is the volume-based cumulative 90% size of the particles which is determined in the same manner as “D50”.

The “melting temperature” is a temperature corresponding to the maximum value of the melting peak of a polymer measured by differential scanning calorimetry (DSC) method.

The “glass transition point (Tg)” is a value measured with respect to a polymer by dynamic viscoelasticity measurement (DMA) method.

The “20% burst pressure” is a pressure measured by ASTM D 3102-78 in such a manner that an appropriate amount of hollow particles are put in glycerin, followed by pressurization, which leads to crushing of the hollow particles and thus a volume reduction, and the pressure under which the volume reduced by 20% is taken as the 20% burst pressure.

The “specific surface area” is a value obtained by measurement with respect to particles by gas desorption BET multipoint method (volumetric method) using NOVA4200e (manufactured by Quantachrome Instruments).

The “viscosity” is obtained by measurement with respect to the composition using a type B viscometer at 25° C. with a number of revolutions of 30 rpm. Measurement is conducted three times, and the average of the three measured values is taken.

The “thixotropic index” is a value calculated by dividing the viscosity η₁ of the composition measured under a number of revolutions of 30 rpm by the viscosity η₂ measured under a number of revolutions of 60 rpm. The respective viscosity measurements are conducted repeatedly three times, and the average of the three measured values is taken.

The “units” of a polymer mean an atomic group based on a monomer formed by polymerization of the monomer. The units may be units directly formed by a polymerization reaction, or may be units having part of the units converted to another structure by treating the polymer. Hereinafter units based on a monomer a may sometimes be referred to simply as “monomer a units”.

The composition of the present invention (hereinafter sometimes referred to as “the present composition”) contain particles of a tetrafluoroethylene-based polymer (hereinafter sometimes referred to as “F polymer”) (hereinafter sometimes referred to as “F particles”) and hollow silica particles with a 20% burst pressure of 120 MPa or more, with a ratio of the specific surface area of the hollow silica particles to the specific surface area of the F particles being more than 1, and with a content of the hollow silica particles being 30 vol % or more.

The present composition is excellent in dispersibility, and from the present composition, a molded product having physical properties of the F polymer and the hollow silica particles highly maintained and having a low coefficient of linear expansion, dielectric constant and dielectric loss tangent, is easily formed. The reason is not clearly understood yet, but is considered as follows.

In the present composition, the ratio of the specific surface area of the hollow silica particles is more than 1 to the specific surface area of the F particles, which may be considered to lead to an easy creation of a state where a large number of the F particles are attached or bond to the surface of the hollow silica particles in he composition. The moderate buffering effect of the F particles, and breaking strength of the hollow silica particles themselves at a certain level or higher, have synergistic effects, and when the present composition is to be processed, not only a state is created where the hollow silica particles hardly break but also dispersibility of the hollow silica particles in the present composition or its processed product is improved.

Accordingly, it is considered that a molded product with a high content of intact hollow silica can easily be obtained even various conditions where a shear force is applied, such as a dispersing treatment at the time of preparation of the present composition containing a liquid medium, or a melt-kneading treatment of the present composition in a powdery state.

It is considered that as a result, a molded product having physical properties of the F polymer and the hollow silica particles highly maintained, and having a low coefficient of linear expansion, dielectric constant and dielectric loss tangent, can be obtained from the present composition.

In the present invention, the F polymer is a polymer containing units based on tetrafluoroethylene (hereinafter sometimes referred to as “TFE”) (hereinafter sometimes referred to as “TFE units”).

The F polymer is preferably heat-meltable. A heat-meltable polymer means a polymer of which a temperature at which the melt flow rate is 1 to 1000 g/10 min under a load of 49 N is present.

The melting temperature of the F polymer is preferably 200° C. or higher, more preferably 260° C. or higher. The melting temperature of the F polymer is preferably 325° C. or lower, more preferably 320° C. or lower. The melting temperature of the F polymer is preferably 200 to 320° C. In such a case, the present composition tends to be excellent in processability, and a molded product formed from the present composition tends to be excellent in heat resistance.

The glass transition point of the F polymer is preferably 50° C. or higher, more preferably 75° C. or higher. The glass transition point of the F polymer is preferably 150° C. or lower, more preferably 125° C. or lower.

The fluorine content of the F polymer is preferably 70 mass % or more, more preferably 72 to 76 mass %.

The surface tension of the F polymer is preferably 16 to 26 mN/m. The surface tension of the F polymer may be measured by placing on a flat plate formed of the F polymer, droplets of wetting tension test mixture (manufactured by Wako Pure Chemical Industries, Ltd.) specified by JIS K 6768.

The F polymer is preferably a polymer containing the TFE units and units based on ethylene (ETFE), a polymer containing the TFE units and units based on propylene, a polymer containing the TFE units and units based on a perfluoro(alkyl vinyl ether) (PAVE) (PAVE units) (PFA), or a polymer containing the TFE units and units based on hexafluoropropylene (FEP), more preferably PFA or FEP, further preferably PFA. Such polymers may further contain units based on another comonomer.

PAVE is preferably CF₂═CFOCF₃, CF₂═CFOCF₂CF₃ or CF₂═CFOCF₂CF₂CF₃ (hereinafter sometimes referred to as “PPVE”), more preferably PPVE.

The F polymer preferably has an oxygen-containing polar group, more preferably has a hydroxy group-containing group or a carbonyl group-containing group, further preferably has a carbonyl group-containing group.

In such a case, the F particles are likely to interact with the hollow silica particles, and the present composition tends to be excellent in dispersibility. Further, a molded product having a low coefficient of linear expansion, dielectric constant and dielectric loss tangent is easily obtained from the present composition.

The hydroxy group-containing group is preferably a group containing an alcoholic hydroxy group, more preferably —CF₂CH₂OH or —C(CF₃)₂OH.

The carbonyl group-containing group is preferably a carboxy group, an alkoxycarbonyl group, an amide group, an isocyanate group, a carbamate group (—OC(O)NH₂), an acid anhydride residue (—C(O)OC(O)—), an imide residue (e.g. —C(O)NHC(O)—), a formyl group, a halogenoformyl group, an urethane group (—NHC(O)O—), a carbamoyl group (—C(O)—NH₂), a ureide group (—NH—C(O)—NH₂), an oxamoyl group (—NH—C(O)—C(O)—NH₂) or a carbonate group (—OC(O)O—), more preferably an acid anhydride residue.

In a case where the F polymer has an oxygen-containing polar group, the number of the oxygen-containing polar groups in the F polymer is preferably 10 to 5000, more preferably 100 to 3000 per 1×10⁶ carbon atoms in the main chain. The number of the oxygen-containing polar groups in the F polymer may be determined by the composition of the polymer of by the method as described in WO2020/145133.

The oxygen-containing polar group may be contained in the units based on a monomer in the F polymer, or may be contained in a terminal end group in the main chain of the F polymer, and the former is preferred. The embodiment of the latter case includes a F polymer having the oxygen-containing polar group as a terminal end group derived from a polymerization initiator, a chain transfer agent or the like, and a F polymer obtained by subjecting the F polymer to plasma treatment or ionizing radiation treatment.

The F polymer is preferably a polymer (1) containing the TFE units and the PAVE units, with a ratio of the PAVE units of 2.0 to 5.0 mol % to all the units, and having no oxygen-containing polar group, or a polymer (2) containing the TFE units and the PAVE units, and having the oxygen-containing polar group. By using such a F polymer, the binding strength between the F polymer and the hollow silica particles tends to improve, and particle shedding from a molded product formed from the present composition tends to be suppressed. Further, spherulites having a relatively small radius are likely to be formed, and thus a molded product formed of the present composition is likely to have high surface properties such as surface smoothness.

The polymer (1) more preferably contains only the TFE units and the PAVE units with a ratio of the PAVE units of more than 2.5 mol % and 5.0 mol % or less to all the units. The polymer (1) having no oxygen-containing polar group means that the number of the oxygen-containing polar groups is less than 500 per 1×10⁶ carbon atoms constituting the polymer main chain. The number of the oxygen-containing polar groups is preferably 100 or less, more preferably less than 50. The lower limit of the oxygen-containing polar group is 1.

The polymer (1) may be produced by using a polymerization initiator, a chain transfer agent or the like which does not allow the terminal end group of the polymer chain to have an oxygen-containing polar group, or may be produced by subjecting the F polymer having an oxygen-containing polar group (e.g. a F polymer having an oxygen-containing polar group derived from the polymerization initiator at the terminal end group of the polymer main chain) to fluorination treatment. The fluorination treatment method may be a method using a fluorine gas (see e.g. JP-A-2019-194314).

The polymer (2) is preferably a polymer containing the TFE units and the PAVE units, having a carbonyl group-containing group, more preferably a polymer containing the TFE units, the PAVE units and units based on a monomer having a carbonyl group-containing group, in amounts of the respective units of 90 to 99 mol %, 0.99 to 9.97 mol % and 0.01 to 3 mol % to all the units. Specific examples of such a F polymer include polymers described in WO2018/16644.

The monomer having a carbonyl group-containing group is preferably itaconic anhydride, citraconic anhydride or 5-norbornene-2,3-dicarboxylic anhydride (hereinafter sometimes referred to as “NAH”), more preferably NAH.

The F particles in the present invention are particles of the F polymer and are non-hollow particles. The F particles may be pellets.

D50 of the F particles is preferably 0.1 μm or more, more preferably 0.3 μm or more, further preferably 1 μm or more, particularly preferably 1.5 μm or more. D50 of the F particles is preferably less than 10 μm, more preferably 8 μm or less, further preferably 6 μm or less, particularly preferably less than 3 μm. That is, D50 of the F particles is preferably 0.1 μm or more and less than 10 μm, more preferably 1.5 μm or more and less than 3 μm.

In such a case, the above mechanism is more likely to be exhibited, and the present composition tends to be excellent in dispersibility and processability. Further, a molded product having a low coefficient of linear expansion, dielectric constant and dielectric loss tangent is likely to be obtained from the present composition.

The specific surface area of the F particles is preferably 0.1 m²/g or more, more preferably 1 m²/g or more, further preferably 5 m²/g or more. The specific surface area of the F particles is preferably 18 m²/g or less, more preferably 10 m²/g or less, further preferably 8 m²/g or less. That is, the specific surface area of the F particles is preferably 0.1 m²/g or more and 18 m²/g or less, more preferably 5 m²/g or more and 18 m²/g or less. In such a case, the above mechanism is more likely to be exhibited, and the present composition tends to be excellent in dispersibility and processability.

The F particles may be used alone or in combination of two or more.

The hollow silica particles may be in any shape including spheres, needles (fibers) and plates, and preferably spheres. In such a case, the present composition tends to be excellent in dispersibility and processability. Further, a molded product excellent in electrical properties is likely to be obtained from the present composition.

The spherical hollow silica particles are preferably substantially perfectly spherical. “Substantially perfectly spherical” means that the ratio of particles with a ratio of the minor axis to the major axis being 0.7 or more, is 95% or more when the particles are observed by a scanning electron microscope (SEM).

The average particle size (D50) of the hollow silica particles is preferably 0.1 μm or more and less than 10 μm. D50 of the hollow silica particles is more preferably 1 μm or more. D50 of the hollow silica particles is more preferably 8 μm or less, further preferably 4 μm or less. D50 of the hollow silica particles is most preferably 1 μm or more and 2 μm or less.

The specific surface area of the hollow silica particles is preferably more than 6.5 m²/g and 100 m²/g or less. The specific surface area of the hollow silica particles is more preferably 10 m²/g or more.

The true density of the hollow silica particles is preferably 0.2 to 1 g/cm³, more preferably 0.3 to 0.8/cm³.

The bulk density of the hollow silica particles is preferably 0.1 to 0.5 g/cm³, more preferably 0.2 to 0.4 g/cm³.

The 20% burst pressure of the hollow silica particles is 120 MPa or more. The 20% burst pressure of the hollow silica particles is preferably 140 MPa or more, more preferably 150 MPa or more. The upper limit of the 20% burst pressure is preferably 400 MPa.

The dielectric constant of the hollow silica particles at a frequency of 1 GHz is preferably less than 3.0.

The dielectric loss tangent of the hollow silica particles at a frequency of 1 GHz is preferably 0.002 or less.

The hollow silica particles may be used alone or in combination of two or more types.

Specific examples of the hollow silica particles include “E-SPHERES” series (manufactured by Envirospheres), “SiliNax” series (manufactured by Nittetsu Mining Co., Ltd.), and “Eccospheres” series (manufactured by Emerson & Cuming).

The hollow silica particles may be surface-treated with a silane coupling agent.

The silane coupling agent may, for example, be vinyltrimethoxysilane, 3-mercaptopropyltrimethoxysilane, 3-methacryloxypropyltriethoxysilane, 3-isocyanatepropyltriethoxysilane, N-phenyl-3-aminopropyltrimethoxysilane, 3-glycidoxypropyltrimethoxysilane, 3-aminopropyltrimethoxysilane, 3-aminopropyltriethoxysilane, p-styryltrimethoxysilane, 3-trimethoxysilylpropylsuccinic anhydride, N-2-(aminomethyl)-8-aminooctyltrimethoxysilane, 3-glycidoxypropylmethyldimethoxysilane, 3-glycidoxypropylmethyldiethoxysilane, 3-glycidoxypropyltriethoxysilane or 2-(3,4-epoxycyclohexyl)ethyltrimethoxysilane.

The method of surface-treating the hollow silica particles with the silane coupling agent may be a method of subjecting a solution containing the silane coupling agent and the hollow silica particles to a mixing treatment, followed by drying. In the mixing treatment, the mixture of the solution and the hollow silica particles may be heated or mixed with water to promote the reaction of the silane coupling agent. Further, the reaction of the silane coupling agent may be accelerated by a reaction catalyst. After drying, the hollow silica particles surface-treated with the silane coupling agent may be shredded or classified.

It is preferred to reduce the sodium content on the surface of the hollow silica particles by dipping them in an alkaline solution or by washing with the alkaline solution. The alkaline solution may be an aqueous ammonium hydroxide solution.

The sodium oxide content on the surface of the hollow silica particles is preferably 1 to 4 mass %. The content may be obtained by XPS surface analysis. When the sodium oxide content is within the above range, the hollow silica particles are likely to interact with the F particles, and the present composition tends to be excellent in dispersibility and processability. Further, a molded product excellent in electric properties, particularly with a low dielectric loss tangent is easily obtained from the present composition.

The amount of sodium extracted from the hollow silica particles with water at 90° C. is preferably 10 mass ppm or less.

The hollow silica particles are surface treated with the silane coupling agent preferably after being dipped in or washed with the alkaline solution. In such a case, the hollow silica particles are likely to interact with the F particles.

It is preferred to remove water from the hollow silica particles by high temperature treatment. In such a case, the water content of a molded product formed from the present composition can be reduced, and the molded product tends to have excellent electrical properties.

The temperature of the high temperature treatment is preferably 500 to 1000° C.

In the present composition, the content of the hollow silica particles is, to the total amount of the present composition, 30 vol % or more, preferably 35 vol % or more. The content is preferably 60 vol % or less. When the content of the hollow silica particles is within the above range, the above-described mechanism is more likely to be exhibited, and a molded product obtained from the present composition tends to have improved electric properties such as dielectric constant and dielectric loss tangent.

In the present composition, the ratio of the specific surface area of the hollow silica particles to the specific surface area of the F particles is more than 1, and is preferably 2 or more, more preferably 3 or more. The upper limit of the ratio is preferably 10 or less. When the ratio of the specific surface area of the hollow silica particles to the specific surface area of the F particles satisfies the above range, the above-described mechanism is more likely to be exhibited, and a molded product obtained from the present composition tends to have a low coefficient of linear expansion, dielectric constant and dielectric loss tangent.

The present composition may further contain other inorganic particles different from the hollow silica particles, within a range where the effects of the present invention can be maintained.

The inorganic compound in the other inorganic particles may be carbon, an inorganic nitride or an inorganic oxide, and may, for example, be carbon fiber, glass, boron nitride, aluminum nitride, beryllia, silica, wollastonite, talc, steatite, cerium oxide, aluminum oxide, magnesium oxide, zinc oxide or titanium oxide. Among them, preferred are boron nitride particles, silicon nitride particles or aluminum nitride particles, which are electroconductive inorganic particles.

D50 of the other inorganic particles is preferably 1 μm or more and 50 μm or less.

The other inorganic particles may be surface-treated.

In a case where the present composition further contains the other inorganic particles, their content is preferably 50 to 100 vol % to the hollow silica particles.

The present composition may further contain other resin different from the F polymer. Such other resin may be contained in the present composition as particles, and in a case where the present composition contains a liquid dispersion medium described later, they may be contained as dissolved or dispersed in the liquid dispersion medium.

The other resin may, for example, be a polyester resin such as a liquid crystalline aromatic polyester, a polyimide resin, a polyamideimide resin, an epoxy resin, a maleimide resin, a urethane resin, a polyphenylene ether resin, a polyphenylene oxide resin or a polyphenylene sulfide resin.

The other resin is preferably an aromatic polymer, more preferably at least one aromatic imide polymer selected from the group consisting of an aromatic polyimide, an aromatic polyamic acid, an aromatic polyamideimide and a precursor of an aromatic polyamideimide. The aromatic polymer is contained in the present composition preferably in the form of a varnish having the aromatic polymer dissolved in the liquid dispersion medium.

Specific examples of the aromatic imide polymer include “UPIA-AT” series (manufacture by UBE Corporation), “Neopulim (registered trademark)” series (manufactured by MITSUBISHI GAS CHEMICAL COMPANY, INC.), “SPIXAREA (registered trademark)” series (manufactured by SOMAR CORPORATION), “Q-PILON (registered trademark)” series (manufactured by PI R&D CO., LTD), “WINGO” series (manufactured by WINGO TECHNOLOGY Co. Ltd.), “Tohmide (registered trademark)” series (manufactured by T&K TOKA), “KPI-MX” series (manufactured by Kawamura Sangyo Co., Ltd.), “HPC-1000” and “HPC-2100D” (manufactured by Showa Denko Materials).

In a case where the present composition further contains other resin, the volume concentration of the other resin to the total volume of the F particles and the hollow silica particles is preferably 0.1 vol % or more, more preferably 1 vol % or more. The volume concentration is preferably 15 vol % or less, more preferably 10 vol % or less.

The present composition may be powdery or may further contain a liquid dispersion medium to be in a liquid form.

The liquid dispersion medium is a compound which is liquid under an atmospheric pressure at 25° C., and is preferably a compound having a boiling point of 50 to 240° C. The liquid medium may be used alone or as a mixture of two or more types. In a case where two liquid dispersion mediums are used, the two liquid dispersion mediums are preferably miscible with each other.

The liquid dispersion medium is preferably a compound selected from the group consisting of water, an amide, a ketone and an ester.

The amide may be N-methyl-2-pyrrolidone, N,N-dimethylformamide, N,N-dimethylacetamide, N,N-dimethylpropanamide, 3-methoxy-N,N-dimethylpropanamide, 3-butoxy-N,N-dimethylpropanamide, N,N-diethylformamide, hexamethylphosphoric triamide or 1,3-dimethyl-2-imidazolidinone.

The ketone may be acetone, methyl ethyl ketone, methyl isopropyl ketone, methyl isobutyl ketone, methyl n-pentyl ketone, methyl isopentyl ketone, 2-heptanone, cyclopentanone, cyclohexanone or cycloheptanone.

The ester may be methyl acetate, ethyl acetate, butyl acetate, methyl lactate, ethyl lactate, methyl pyruvate, ethyl pyruvate, methyl methoxypropionate, ethyl ethoxypropionate, ethyl 3-ethoxypropionate, γ-butyrolactone or γ-valerolactone.

In a case where the present composition contains a liquid dispersion medium, the content of the liquid dispersion medium is, to the total amount of the present composition, preferably 40 vol % or more, more preferably 50 vol % or more. The content of the liquid dispersion medium is preferably 90 vol % or less, more preferably 80 vol % or less.

In a case where the present composition contains the liquid dispersion medium, the solid content concentration of the present composition is preferably 20 vol % or more, more preferably 40 vol % or more. The solid content concentration is preferably 80 vol % or less, more preferably 70 vol % or less. The solid content means the total amount of substances forming the solid content in the molded product formed from the present composition. Specifically, the F particles and the hollow silica particles are solid contents, and in a case where the present composition contains the other inorganic particles or the other resin, such other inorganic particles and other resin are also solid contents, and the total volume concentration of such components is the solid content concentration of the present composition.

In a case where the present composition contains the liquid dispersion medium, the present composition preferably further contains a nonionic surfactant, with a view to further improving dispersion stability of the F particles and the hollow silica particles.

The nonionic surfactant is preferably a glycol-based surfactant, an acetylene-based surfactant, a silicone-based surfactant or a fluorinated surfactant, more preferably a silicone-based surfactant. The nonionic surfactant may be used alone or in combination of two or more types. In a case where two types of nonionic surfactants are used, the nonionic surfactants are preferably a silicone-based surfactant and a glycol-based surfactant.

Specific examples of the nonionic surfactant include “FTERGENT” series (manufactured by NEOS COMPANY LIMITED), “SURFLON” series (manufactured by AGC Seimi Chemical Co., Ltd.), “MEGAFACE” series (manufactured by DIC Corporation), “UNIDYNE” series (manufactured by DAIKIN INDUSTRIES, LTD.), “BYK-347”, “BYK-349”, “BYK-378”, “BYK-3450”, “BYK-3451”, “BYK-3455”, “BYK-3456” (manufactured by BYK Japan), “KF-6011”, “KF-6043” (manufactured by Shin-Etsu Chemical Co., Ltd.), “Tergitol” series (manufactured by Dow Chemical, “Tergitol TMN-100X” etc.).

In a case where the present composition contains the nonionic surfactant, the content of the nonionic surfactant in the present composition is preferably 1 to 15 vol %.

The present composition may further contain a silane coupling agent. In such a case, the binding strength between the F particles and the hollow silica particles will further improve, and particle shedding of a molded product formed from the present composition tends to be suppressed.

The silane coupling agent may be the same as the silane coupling agent which may be used for the surface treatment of the hollow silica particles, and the preferred range is also the same.

In a case where the present composition contains the silane coupling agent, the content of the silane coupling agent in the present composition is preferably 1 to 10 vol %.

The present composition may further contain an additive such as a thixotropy-imparting agent, a viscosity adjusting agent, a defoaming agent, a dehydrating gent, a plasticizer, a weathering gent, an antioxidant, a thermal stabilizer, a lubricant, an antistatic agent, a brightening agent, a coloring agent, a conductive agent, a mold release agent, a surface treatment agent or a flame retardant.

In a case where the present composition further contains the above described other inorganic particles, other resin, liquid dispersion medium, nonionic surfactant, silane coupling agent or additive, the content of the F particles is preferably 25 mass % or more to the total amount of the composition.

In a case where the present composition contains the liquid dispersion medium and is in a liquid form, the viscosity is preferably 10 mPa·s or more, more preferably 100 mPa·s or more. The viscosity of the present composition is preferably 10000 mPa·s or less, more preferably 3000 mPa·s or less.

In a case where the present composition contains the liquid dispersion medium and is in a liquid form, the thixotropic ratio is preferably 1.0 to 3.0.

In a case where the present composition contains water as the liquid dispersion medium, its pH is preferably 8 to 10 with a view to improve long term storage life. The pH of the present composition may be adjusted e.g. with a pH adjusting agent (e.g. amine, ammonia, citric acid) or a pH buffering gent (e.g. tris(hydroxymethyl)aminomethane, ethylenediaminetetraacetate, ammonium hydrogen carbonate, ammonium carbonate or ammonium acetate).

The present composition may be obtained by mixing the F particles and the hollow silica particles, and as the case requires, the other inorganic particles, the other resin, the liquid dispersion medium, the nonionic surfactant, the silane coupling agent, the additive, etc.

The present composition may be obtained by mixing the F particles and the hollow silica particles all at once, may be obtained by separately mixing them sequentially, or may be obtained by forming them into respective master batches, and mixing them with the other components. The order of mixing is not particularly limited, and the mixing may be conducted all at once or in divided portions.

The mixing apparatus to obtain the present composition may be a stirring apparatus equipped with a blade, such as a Henschel mixer, a pressure kneader, a Banbury mixer or a planetary mixer, a grinding apparatus sch as a ball mill, an attritor, a basket mill, a sand mill, a sand grinder, a DYNO-mill, a DISPERMAT, a SC mill, a spike mill or an agitator mill, or a dispersing apparatus with another function, such as a microfluidizer, a nanomizer, an ultimizer, an ultrasonic homogenizer, a dissolver, a disper, a high speed impeller, a high speed thin film mixer, a planetary stirring machine or a V-mixer.

From the present composition, by the above described mechanism, a molded product having a dielectric constant of 2.8 or less and a dielectric loss tangent of 0.0025 or less is easily obtained. The dielectric constant of the molded product is preferably 2.4 or less, more preferably 2.0 or less. Further, the dielectric constant is preferably more than 1.0. The dielectric loss tangent of the molded product is preferably 0.0022 or less, more preferably 0.0020 or less. The dielectric loss tangent is preferably more than 0.0010.

By subjecting the present composition to molding such as extrusion, a sheet-shaped molded product may be obtained.

In a case where the present composition contains the liquid dispersion medium and is in a liquid form, the present composition is preferably extruded into a sheet. The sheet obtained by extrusion may further be stretched by e.g. pressing or calendaring. The sheet is preferably further heated to remove the liquid dispersion medium and to fire the F polymer.

In a case where the present composition is powdery, the present composition is preferably melt-extruded. The extrusion may be conducted e.g. by a single screw extruder or a multi-screw extruder.

The present composition may be injection-molded to obtain a molded product.

For formation of the molded product, the present composition may be directly melt-extruded or injection-molded, or the present composition may be melt-kneaded into pellets, which are melt-extruded or injection-molded to obtain a molded product such as a sheet.

The thickness of the sheet obtained from the present composition is preferably 25 μm or more, more preferably 30 μm or more, further preferably 40 μm or more, particularly preferably 50 μm or more, most preferably 100 μm or more. The thickness of the sheet is preferably 500 μm or less, more preferably 200 μm or less. By the above-described mechanism, the sheet obtained from the present composition is likely to highly exhibit physical properties such as surface smoothness, adhesion and low linear expansion, and electrical properties, even with such a thickness.

Preferred ranges of the dielectric constant and the dielectric loss tangent of the sheet are respectively the same as the ranges of the dielectric constant and the dielectric loss tangent of the above described molded product.

The coefficient of linear expansion of the sheet is preferably 100 ppm/° C. or lower, more preferably 80 ppm/° C. or lower. The lower limit of the coefficient of linear expansion of the sheet is 30 ppm/° C. The coefficient of linear expansion means a value of the coefficient of linear expansion of a test specimen measured at 25° C. or higher and 260° C. or lower in accordance with the method specified by JIS C 6471: 1995.

The coefficient of thermal conductivity of the sheet in-plane direction is preferably 1.0 W/m·K or more, more preferably 3.0 W/m·K or more. The upper limit of the coefficient of thermal conductivity of the sheet is 20 W/m·K.

By laminating such a sheet on a substate, a laminate can be formed. To form a laminate, a method of extruding the present composition together with the material of the substrate using a co-extruder as the above extruder, a method of extruding the present composition on the substrate, or a heat-bonding the sheet and the substrate may, for example, be mentioned.

As the substrate, a metal substrate (e.g. a metal foil of copper, nickel, aluminum, titanium, an alloy thereof, or the like), a heat resistant resin film (a heat resistant resin film of polyimide, polyamide, polyether amide, polyphenylene sulfide, polyallyl ether ketone, polyamide-imide, liquid crystalline polyester, tetrafluoroethylene-based polymer or the like), a prepreg substrate (precursor of a fiber-reinforced resin substrate), a ceramic substrate (a ceramic substrate of silicon carbide, aluminum nitride, silicon nitride or the like), or a glass substrate may be mentioned.

The substrate may be flat, curved or textured. The substrate may be in any of a foil, plate, film or fiber shaped.

The ten-point mean roughness of the substrate is preferably 0.01 to 0.05 μm.

The substrate may be surface-treated with the silane coupling agent.

The peel strength between the sheet and the substrate is preferably 10 N/cm or more, more preferably 15 N/cm or more. The peel strength is preferably 100 N/cm or less.

By disposing the present composition on the surface of the substrate and forming a polymer layer containing the F polymer and the hollow silica particles (hereinafter sometimes referred to as “F layer”), a laminate having a substrate layer constituted by the substrate and the polymer layer can be obtained.

The F layer is formed preferably by disposing the present composition containing the liquid dispersion medium on the surface of the substrate, followed by heating to remove the dispersion medium, further by heating to fire the F polymer.

As the substrate, the same one as the substrate which can be laminated with the sheet, and the preferred embodiment is also the same.

To dispose the present composition, a coating method, a droplet discharge method or a dipping method may be mentioned, and preferred is a roll coating method, a knife coating method, a bar coating method, a die coating method or a spray coating method.

The heating for removal of the liquid dispersion medium is conducted preferably at 100 to 200° C. for 0.1 to 30 minutes. By this heating, the liquid dispersion medium may not necessarily completely be removed, and should be removed to such an extent that a layer formed by packing of the F particles and the hollow silica particles can maintain a self-supporting film. At the time of heating, air may be blown for air-drying to promote removal of the liquid dispersion medium.

Heating for firing the F polymer is conducted preferably at the firing temperature of the F polymer or higher, more preferably at 360 to 400° C. for 0.1 to 30 minutes.

The heating apparatus for the respective heatings may be an oven or an air drying furnace. The heat source in the apparatus may be a contact heat source (e.g. heated air or heated plate) or a noncontact heat source (e.g. infrared ray).

The respective heatings may be conducted under norma pressure or under reduced pressure.

The respective heatings may be conducted in any of an air atmosphere and an inert gas (e.g. helium gas, neon gas, argon gas or nitrogen gas) atmosphere.

Preferred specific examples of the laminate include a metal-lined laminate having a metal foil and the F layer on at least one surface of the metal foil, and a multilayered film having a polyimide film and the F layer on each surface of the polyimide film.

Preferred ranges of the thickness, dielectric constant, dielectric loss tangent, coefficient of linear expansion and coefficient of thermal conductivity in in-plane direction of the F layer, and peel strength between the F layer and the substrate layer, are the same as the preferred ranges of the thickness, dielectric constant, dielectric loss tangent, coefficient of linear expansion and coefficient of thermal conductivity in in-plane direction of the sheet obtained from the present composition, and peel strength between the sheet and the substrate.

The present composition is useful as a material to impart insulating property, heat resistance, corrosion resistance, chemical resistance, water resistance, impact resistance and thermal conductivity.

The present composition is applicable specifically to printed circuit boards, thermal interface materials, power module boards, coils used for power plants such as motors, on-board engines, heat exchangers, vials, syringes, ampules, medical wires, secondary batteries such as lithium ion batteries, primary batteries such as lithium batteries, radical batteries, solar cells, fuel cells, lithium ion capacitors, hybrid capacitors, capacitors, condensers (aluminum electrolysis condensers, tantalum electrolysis condensers, etc.), electrochromic devices, electrochemical switching elements, biners of electrodes, separators of electrodes, and electrodes (positive electrodes, negative electrodes).

The present composition is useful also as an adhesive to bond members. Specifically, the present composition is applicable to bonding of ceramic components, bonding of metal components, bonding of IC chips and electronic components such as resistors and condensers on substrates of semiconductor devices or module members, bonding of circuit boards and radiator plates, and bonding of LED chips to substrates.

Further, the present composition, which further contains electroconductive inorganic particles, is useful even in fields in which electrical conductivity is required, for example, in the field of printed electronics. Specifically, the present invention is applicable to production of printed circuit boards, and photoconductive elements in e.g. sensor electrodes.

The molded product, sheet and laminate formed from the present composition is useful for antenna components, printed circuit boards, aircraft members, automobile members, sports goods, food industry members, heat radiating members, coating materials, cosmetics, etc.

Specifically, they are useful as wire covering materials (wires for aircrafts, flat wires, FFC (flexible flat cables), etc.), enameled wire covering materials to be used for e.g. motors of electric cars, covering materials for electric heat generation, electric insulating tapes, insulating tapes for oil drilling, oil transfer hoses, hydrogen tanks, printed circuit board materials, separation membranes (microfiltration membranes, ultrafiltration membranes,, reverse osmosis membranes, ion exchange membranes, dialysis membranes, gas separation membrane, etc.), electrode binders (for lithium ion secondary batteries, for fuel cells, etc.), carrier films for fuel cells, tape base films for semiconductor production (dicing tapes, pick up tapes, etc.), release films for semiconductor molding, liquid crystalline antennas, reflecting plates, transmission lines, base films for COFs (chips on film), electrostatic chucks for semiconductor production process, electrostatic chucks for display production process, copy rolls, furniture, automobile dashboards, covers for home appliances, sleeve members (load bearing, yaw bearings, plain bearings, valves, bearings, bushes, seals, thrust washers, wear rings, pistons, slide switches, gears, cams, belt conveyers, food transfer belts, etc.), tension ropes, wear pads, wear strips, tube lamps, test sockets, wafer guides, wear parts of centrifugal pumps, chemical and water supply pumps, industrial tools (shovels, files, drills, saws, etc.), boilers, hoppers, pipes, ovens, baking molds, chutes, guts of rackets, dies, toilet bowls, container covering materials, mounting radiating boards for power devices, radiating members for radio communication devices, transistors, thyristors, rectifiers, transformers, power MOS FET, CPU, radiating fins, metal heat sinks, blades of windmills, wind turbine generator systems, aircrafts, etc., housings for personal computers and displays, electronic device materials, automobile interior/exterior parts, processing machines or vacuum ovens for heat treatment under low oxygen atmosphere, sealing materials of plasma treatment device and the like, radiating members in process units such as sputtering apparatus and dry etching devices, and electromagnetic shielding.

The molded product, sheet and laminate obtained from the present composition are useful for electric boards materials of flexible printed wiring boards, rigid printed wiring boards and the like, protective films and radiating substrates, particularly radiating substrates for automobiles.

When the molded product, sheet and laminate obtained from the present composition are used as radiating members, the molded product, sheet or laminate may directly be bonded to the substrate, or may be bonded to the substrate via an adhesive layer such as a silicone-based adhesive layer.

### EXAMPLES

Now, the present invention will be described in further detail with reference to Examples. However, it should be understood that the present invention is not limited thereto.

### 1. Preparation of the Respective Components

### [F Particles]

F particles 1: particles of tetrafluoroethylene-based polymer (melting temperature: 300° C.) containing TFE units, NAH units and PPVE units in amounts of 97.9 mol %, 0.1 mol % and 2.0 mol %, respectively, having 1000 carbonyl group-containing groups per 1×10⁶ main chain carbon atoms (D50: 1.9 μm, specific surface area: 6 m²/g)

F particles 2: particles of the tetrafluoroethylene-based polymer (melting temperature: 300° C.) (D50: 3.2 μm, specific surface area: 4 m²/g)

F particles 3: particles of the tetrafluoroethylene-based polymer (melting temperature: 300° C.) (D50: 1.2 μm, specific surface area: 19 m²/g)

### [Hollow Silica Particles]

Hollow silica particles 1: spherical and hollow silica particles with substantially perfect sphericity (D50: 1.2 μm, specific surface area: 20 m²/g, 20% burst pressure: 160 MPa)

Hollow silica particles 2: spherical and hollow silica particles with substantially perfect sphericity (D50: 1.2 μm, specific surface area: 22 m²/g, 20% burst pressure: 110 MPa)

Hollow silica particles 3: spherical and hollow silica particles with substantially perfect sphericity (D50: 16.0 μm, specific surface area: 6 m²/g, 20% burst pressure: 140 MPa)

### [Liquid Dispersion Medium]

NMP: N-methyl-2-pyrrolidone

### 2. Examples of Production of Composition

### Ex. 1 to 5

NMP and a powder mixture of the F particles 1 and the hollow silica particles 1 were put into a pot and mixed to prepare a mixture, which was kneaded in a planetary mixer and discharged to obtain a wet powder kneaded powder 1.

While NMP was added in divided portions to the kneaded powder 1, the kneaded powder 1 was stirred by a planetary mixer at 2000 rpm while removing bubbles. NMP was further added in divided portions and the mixture was stirred to prepare a liquid composition, thereby to obtain composition 1 containing 25 mass % of the F particles 1, 55 vol % of the hollow silica particles 1 and NMP.

Compositions 2 and 3 were obtained in the same manner as above except that the hollow silica particles 2 and the hollow silica particles 3 were respectively used instead of the hollow silica particles 1. Further, compositions 4 and 5 were obtained in the same manner as above except that the F particles 2 and the F particles 3 were respectively used instead of the F particles 1.

### 3. Production of Laminate

On the surface of a continuous-length copper foil having a thickness of 18 μm, the composition 1 was applied by a bar coater to form a wet film. The copper foil having the wet film formed thereon was dried in a drying oven at 110° C. for 5 minutes to form a dry film. The copper foil having the dry film was heated in a nitrogen oven at 380° C. for 3 minutes, whereby laminate 1 having the copper foil and on its surface a polymer layer containing the hollow silica particles 1 and a melt-fired product of the F particles 1, having a thickness of 100 μm, was produced.

Laminates 2 to 5 were produced from the compositions 2 to 5 in the same manner as the laminate 1.

### 4. Evaluation

### 4-1. Evaluation of Surface Properties of Laminate

The surface of the polymer layer of each laminate was visually observed to evaluate as to whether shedding of the hollow silica particles occurred or not, based on the following standards, and the peel strength between the polymer layer and the copper foil was measured.

The peel strength was measured using a test sample cut out from the obtained laminate into a strip specimen with a length of 100 mm and a width of 10 mm. Specifically, the polymer layer was peeled from the copper foil at 90° to a position of 50 mm from one end in the length direction of the laminate using a tensile strength tester (manufactured by ORIENTEC CO., LTD) at a pulling rate of 50 mm/min, and the maximum load applied was taken as the peel strength.

### [Evaluation Standard of Powder Shedding]

◯: no shedding of the hollow silica particles observed, the polymer layer surface being flat and smooth, and the peel strength being 15 N/cm or more.

Δ: no shedding of the hollow silica particles observed but fine roughness observed on the polymer layer surface, and the peel strength being 10 N/cm or more and less than 15 N/cm.

X: breakage and shedding of some hollow silica particles observed and fine roughness observed on the polymer layer surface, and thus the peel strength not measured.

### 4-2. Evaluation of Electrical Properties of Laminate

The copper foil on each laminate was removed by etching with an aqueous ferric chloride solution to prepare a polymer layer itself as a sheet. A 5 cm×10 cm test specimen was cut out from the center portion of the prepared sheet, the dielectric constant and the dielectric loss tangent (measurement frequency: 1 GHz) of the sheet were measured by SPDR (split post dielectric resonance) method and evaluated based on the following standards.

### [Evaluation Standards of Electrical Properties]

◯: the dielectric constant being less than 2.8 and the dielectric loss tangent being 0.0020 or less.

Δ: the dielectric constant being less than 2.8, and the dielectric loss tangent being more than 0.0020.

X: the dielectric constant being more than 2.8, and the dielectric loss tangent being more than 0.0020.

The above results are summarized in Table 1.

TABLE 1

| Laminate | 1 | 2 | 3 | 4 | 5 |
|---|---|---|---|---|---|
| Surface proeprties | ◯ | X | ◯ | Δ | ◯ |
| Electrical properties | ◯ | Δ | X | ◯ | Δ |

### INDUSTRIAL APPLICABILITY

The present composition is excellent in dispersion stability, and a laminate formed from the present composition highly exhibits physical properties of the F polymer and the hollow silica particles and is excellent in electrical properties.

The entire disclosure of Japanese Patent Application No. 2023-062181 filed on Apr. 6, 2023, including specification, claims and summary is incorporated herein by reference in its entirety.

1. A composition comprising particles of a tetrafluoroethylene-based polymer and hollow silica particles with a 20% burst pressure of 120 MPa or more, with a ratio of the specific surface area of the hollow silica particles to the specific surface area of the particles of the tetrafluoroethylene-based polymer being more than 1 and with a content of the hollow silica particles being 30 vol % or more.

2. The composition according to claim 1, wherein the tetrafluoroethylene-based polymer contains units based on a perfluoro(alkyl vinyl ether).

3. The composition according to claim 1, wherein the tetrafluoroethylene-based polymer is a heat-meltable tetrafluoroethylene-based polymer having a carbonyl group-containing group.

4. The composition according to claim 1, wherein the particles of the tetrafluoroethylene-based polymer have an average particle size of 0.1 μm or more and less than 10 μm.

5. The composition according to claim 1, wherein the particles of the tetrafluoroethylene-based polymer have a specific surface area of 5 m²/g or more and 18 m²/g or less.

6. The composition according to claim 1, wherein the hollow silica particles have an average particle size of 0.1 μm or more and less than 10 μm.

7. The composition according to claim 1, wherein the hollow silica particles have a specific surface area of more than 6.5 m²/g and 100 m²/g or less.

8. The composition according to claim 1, wherein the content of the hollow silica particles is 35 vol % or more and 60 vol % or less.

9. The composition according to claim 1, wherein the hollow silica particles have a dielectric constant of less than 3.0 at a frequency of 1 GHz.

10. The composition according to claim 1, wherein the hollow silica particles have a dielectric loss tangent of 0.002 or less at a frequency of 1 GHz.

11. The composition according to claim 1, wherein the ratio of the specific surface area of the hollow silica particles to the specific surface area of the particles of the tetrafluoroethylene-based polymer is 2 or more and 10 or less.

12. The composition according to claim 1, used to obtain a molded product having a dielectric constant of 2.8 or less and a dielectric loss tangent of 0.0025 or less.

13. A method for producing a sheet, which comprises extruding the composition as defined in claim 1 to obtain a sheet comprising the tetrafluoroethylene-based polymer and the hollow silica particles.

14. A method for producing a laminate, which comprises disposing the composition as defined in claim 1 on the surface of a substrate, and forming a polymer layer containing the tetrafluoroethylene-based polymer and the hollow silica particles, thereby to obtain a laminate having a substrate layer composed of the substate and the polymer layer.
